(19) United States
(12) Patent Application Publication
(10) Pub. No.: US 2026/0013023 A1
(43) Pub. Date: Jan. 8, 2026

(54) DISCHARGE DEVICE

(71) Applicant: SCHUNK TRANSIT SYSTEMS GMBH, Wettenberg (DE)

(72) Inventors: DANIEL PFEFFER, Muecke (DE); Philipp Hornik, Reiskirchen (DE); Ralf Hoerr, Biebertal (DE); Tom Nusch, Wettenberg (DE); Steffen Weller, Wetzlar (DE); Ralf Gaertner, Lahnau (DE)

(21) Appl. No.: 17/925,909

(22) PCT Filed: May 20, 2020
(86) PCT No.: PCT/EP2020/064133

§ 371 Date: Aug. 18, 2025

(51) Int. Cl. H05F 3/04; B61K 13/00

(52) U.S. Cl. CPC H05F 3/04; B61K 13/00

(57) ABSTRACT

A conductor element, a rail vehicle having a conductor element and a method for conducting electrostatic charges from a shaft, the conductor element comprising a holder and a conductor assembly, the holder having a holder ring and the conductor assembly having at least one elastic conductor disposed on the holder, the conductor being made of a carbon fiber assembly and having a shaft contact section for contacting the shaft, the shaft being tangentially contacted at a circumference of the shaft by means of the conductor. The conductor element has at least one positioning element, the conductor being held at the positioning element and the positioning element being disposed in such a manner on the holder that a position of the shaft contact section is set in relation to the shaft.

The present application is a national stage application filed under 35 U.S.C. § 371 of International Application No. PCT/EP2020/064 133, filed May 20, 2020, which is incorporated by reference in its entirety for all purposes.

The disclosure relates to a conductor element, to a rail vehicle having a conductor element and to a method for conducting electrostatic charges from a shaft, the conductor element comprising a holder and a conductor assembly, the holder having a holder ring and the conductor assembly having at least one elastic conductor disposed on the holder, the conductor being made of a carbon fiber assembly and having a shaft contact section for contacting the shaft, the shaft being tangentially contacted at a circumference of the shaft by means of the conductor.

Conductor elements of the type mentioned above are sufficiently known. In this context, an annular conductor element commonly surrounds the shaft around its circumference, carbon fibers being disposed on the conductor element, for example in bundles, and their free ends brushing along a circumference of the rotating shaft, the carbon fibers contacting the shaft in this manner. Alternatively, the ends of the carbon fibers can be clamped on the holder of the conductor element, the section between the ends of the carbon fibers touching the circumference of the rotating shaft. A disadvantage in this case is that conductors of this type must always be directly mounted on the conductor element, a fact which encumbers in particular servicing the conductor element when the conductor has become worn. In this instance, the conductors must be disposed on the holder of the conductor element, which at this point is in the device in which the conductor element is installed, the holder being difficult to access and a particularly safe mounting of the conductors possibly not being able to be ensured. This leads to the conductor not being able to be set correctly in its position when mounted faultily, the conductor not or not sufficiently contacting the shaft which is critical in particular when the shaft has normal vibrations during operation of the device. The conductor can also detach or fall off of the holder as a consequence of a faulty mounting, a conducting of electrostatic charges from the shaft being inhibited and damage being able to be caused to the device, in which the conductor element is installed.

It is therefore the object of the disclosure at hand to propose a conductor element which enables reliably contacting a shaft and moreover can be produced inexpensively and easily.

This object is attained by a conductor element having the features of claim 1, a rail vehicle having the features of claim 21 and a method having the features of claim 22.

The conductor element for conducting electrostatic charges from a shaft comprises a holder and a conductor assembly, the holder having a holder ring and the conductor assembly having at least one elastic conductor disposed on the holder, the conductor being made of a carbon fiber assembly and having a shaft contact section for contacting the shaft, the shaft being able to be contacted tangentially at a circumference of the shaft by means of the conductor. The conductor element has at least one positioning element, the conductor being held at the positioning element and the positioning element being disposed in such a manner on the holder that a position of the shaft contact section can be set in relation to the shaft.

The conductor element according to the disclosure can, for example, be used in gears of rail vehicles or other industrial machines. In this context, the conductor can exert a contact force on a circumference of the shaft, whereby the shaft can be reliably contacted despite motions or vibrations which can arise during operation of the shaft. A contact force of the conductor can be set via a prestressing which can be attained by the conductor element being able to be disposed at a defined distance to a circumference of the shaft. Owing to being made of carbon fibers, the conductor has a particularly long service life, whereby the conductor element according to the disclosure can be used for a particularly long period of time in a corresponding device. To this end, the conductor is conductively connected to the holder, the holder being able to be made of metal, preferably aluminum. Alternatively, the holder ring of the holder can be made of plastic, an additional conductive connection, for example in the form of a metal wire, preferably a copper wire, being able to be provided between the conductor and the holder for conducting the electrostatic charge. The conductor element according to the disclosure moreover can be suitable for the use of shafts having different circumferences and diameters since the conductor producing the contact force can have a larger range than would be necessary for a mere contacting of an individual shaft via touch. Wear of the conductor element according to the disclosure, in particular wear of the conductor, can be determined beforehand due to a defined contact force or contact pressure, which in turn simplifies servicing the conductor element. By using a positioning element, the disclosure intends the position of the shaft contact section of the conductor to be settable in relation to the shaft. In this context, an orientation of the conductor is settable in relation to a circumference of the shaft, the conductor contacting the shaft radially and/or tangentially via the shaft contact section. The position of the shaft contact position and/or the orientation of the conductor in relation to the shaft is set by correspondingly fastening the positioning element on the holder. Alternatively, the positioning element can be fastened on the holder, an approximate orientation of the conductor being settable, and subsequently a finer adjustment of the conductor within the positioning element can be set, meaning the conductor reliably contacts the shaft at the circumference. The positioning element can be made of the same material as the holder, the positioning element being realized so as to be conductive, for example by being made of the same material as the holder ring, and having a low-impedance resistance, meaning the electrostatic charge can be easily conducted by the conductor. The conductor is simply disposed on the positioning element, this being able to take place outside of the device in which the conductor element is installed. In a second step, the positioning element can be fastened to the holder using the conductor, the holder being able to have suitable fastening means or fastening elements. The positioning element and/or the conductor can thus be easily and safely mounted by a specialist, even when the holder ring is already installed in the device, fastening means or fastening elements of this kind on the holder ring being known to the specialist. Moreover, the positioning element can be used for a plurality of holders, shafts having different diameters being able to be contacted via corresponding conductor elements. For this purpose, diameters of the corresponding holder rings of the holders can always be larger than the circumferential diameter of the corresponding shafts. The conductor element according to the disclosure thus does not only enable a simple and reliable first mounting of the conductors, but also to easily exchange these, for example because of wear, by using the positioning element according to the disclosure. A simple forming of the mentioned components of the conductor element according to the disclosure, in particular because of the materials mentioned, allows easily and inexpensively producing the conductor element.

In this context, it is advantageous when the carbon fiber assembly is made of a braid of carbon fibers, the carbon fiber element being able to be inherently stable in such a manner because of the infiltration with pyrolytic carbon that a contact force can be applied to the shaft via the carbon fiber assembly. The carbon fiber assembly of the conductor can have a braid made of carbon fibers infiltrated with pyrolytic carbon, whereby the carbon fiber assembly can obtain an intrinsic stability. In this case, the infiltration of the carbon fiber assembly having pyrolytic carbon can be yielded for example by means of chemical vapor infiltration (CVI method). The carbon fibers can be weaved or individual fibers. Moreover, a braid of carbon fibers can be weaved around individual parallel carbon fibers. The conductor made of carbon fibers is immune to corrosion and chemical substances and contributes to the forming of a carbon patina on the shaft, the carbon patina causing dry lubrication of the conductor. In addition, the carbon fibers of the conductor can have advantageous tribological properties and thus promote a reduced heat generation when contacting the shaft. Furthermore, the carbon fiber assembly can generate capillarity which arises in the gaps between the carbon fibers and allows sluicing impurities, such as fat or liquid, in the area of the contacting. For this purpose, the degree of infiltration and/or the amount of infiltrated pyrolytic carbon defines a rigidity of the carbon fiber assembly. In this context, the carbon fiber assembly can exert a contact force, which is influenced by at which distance the conductor element is mounted with respect to the shaft. From this contact force, the service life of the carbon fiber assembly can be determined, since wear of the carbon fiber assembly can be determined beforehand.

The positioning element can be disposed on an inner circumference of the holder ring or on a front face of the holder ring, the positioning element being able to be connected to the holder ring in a forcefitting and/or form-fitting manner. A position of this kind of the holder ring enables contacting a circumference of the shaft. The holder can be realized in such a manner that it has at least one fastening means and/or a fastening element on its front face and/or on an inner circumference for fastening the positioning element. For instance, the positioning element can be screwed to the holder ring. Moreover, the positioning element and the holder ring can be connected non-permanently, whereby mounting and demounting the positioning element and/or the conductor element is simplified. The positioning element can be inserted into a recess of the holder ring formed according to the positioning element. The positioning element can also be connected to the holder ring in a force-fitting and/or form-fitting manner in the area of the recess. The positioning element can be partially or completely inserted into the recess. To this end, the recess can be realized in such a manner that it is suitable for completely or partially receiving the positioning element. The positioning element and the recess can have contours which are suitable for forming a snap connection. Alternatively, the positioning element can be screwed to the holder ring. In this case, the recess defines a holding position and thus a position of the positioning element and/or of the conductor, which is inserted into the positioning element, on the holder ring, a position of the shaft contact section being set in relation to the shaft.

The holder ring can moreover have two or more recesses. In this context, the recesses can each be suitable for partially or completely receiving a positioning element. The recesses can also each be disposed on a front face and/or an inner circumference of the holder ring. In this context, the positioning element and/or the conductor held in the positioning element can be oriented in relation to the shaft by inserting the positioning element in one of the recesses that a position of the shaft contact section is set in relation to the shaft. In this context, the conductor can be positioned and/or oriented in relation to a circumference of the shaft in a coinciding or differing manner. In this context, it is advantageous if each of the recesses enable a different position of the shaft contact section and/or a different orientation of the conductor in relation to a circumference of the shaft. This requires that shafts having different diameters can also be contacted by the same conductor, as an orientation of the conductor can be set by inserting the positioning element into the corresponding recess. Alternatively, two or more positioning elements can also be mounted in two or more recesses at the same time at the same conductor element, a coinciding or a different position of the shaft contact sections of the corresponding conductor being able to be set in relation to the shaft via the recesses.

The positioning element can be cuboidal or cylindrical in shape and have at least one opening, into which the conductor can be inserted. Holder elements realized in this manner can be produced in large numbers particularly easily and inexpensively. Moreover, different shapes are conceivable for the holder element. The opening can also be realized as a through hole, for example a bore. In addition, the positioning element can have two or more openings which are each suitable for receiving conductors having the same or different conductor cross sections. For instance, the positioning element can have openings, in particular bores, having differently sized diameters, conductors having corresponding diameters being able to be inserted into openings of this kind.

In this context, it is advantageous if the positioning element and the conductor are connected in a non-permanent manner. The conductor is then inserted into the positioning element in a force-fitting and/or form-fitting manner. A connection of this kind between the positioning element and the conductor allows stably holding the conductor on the positioning element. Moreover, the conductor can be simply exchanged, for example because of wear, a new conductor being able to be inserted into the positioning element after removing the first conductor. The conductor can also be mounted according to the desired specifications when mounting the conductor on the shaft, meaning that the corresponding conductor can be chosen flexibly or not be cut to the desired length until mounting it.

The conductor can also be realized as a conductor section having two opposite ends. A conductor section of this kind, which is made of at least one carbon fiber assembly, can be produced particularly easily and can be produced in large numbers inexpensively. It can also be intended to fasten the conductor section to the positioning element.

The ends of the conductor section can be fastened to the holder, both ends of the conductor section being able to be fixated to the positioning element. A conductor section fixated in this manner is fastened to the positioning element in a particularly stable manner, which promotes the service life of the conductor. Owing to the fact that the ends of the conductor section can be fastened at a distance to each other which is smaller than the overall length of the conductor section, whereby the section between the ends is curved towards the shaft, a prestressing of the conductor can moreover be set.

Alternatively, it can be intended that the conductor section can have at least one free end. The conductor section can also have two free ends. The free end can serve for contacting the shaft, which is advantageous in particular when the holder ring or the positioning element is spaced further from a circumference or a front face of the shaft. The free end then forms the wave contact section.

The conductor section can have an end fastened to the positioning element. Another end of the conductor section can be a free end. The end of the conductor section can be connected to the positioning element in a force-fitting and/or form-fitting manner. To this end, the end of the conductor section can be inserted into a depression or an opening of the positioning element.

The conductor section can have at least one section between the ends, the conductor section being fastened on the section on the positioning element and/or holder. For this purpose, a particularly flexible fastening of the conductor section to the positioning element is possible, since generally every area between the ends of the conductor section can be fixated, meaning the ends of the conductor section are spaced apart at differing distances from an inner circumference or a front face of the holder ring. At least one end or another section of the conductor section can then form the shaft contact section.

Reference is made to the fact that the fastening of the conductor section is not limited to one of the embodiments mentioned above: rather, a combination of the fastening options mentioned above is possible. It is advantageous if the shaft contact section is formed on the free end of the conductor section or between the ends of the conductor section. In each case, the shaft contact section is not formed by an end fastened on the positioning element or a section of the conductor section, meaning that the shaft contact section can always be disposed so as to be spaced apart from the holder ring or the positioning element. This results in the shaft not being able to be come into contact with the holder ring or the positioning element and thus in damage to the holder ring or the positioning element resulting from friction being prevented via the shaft. The conductor section is exposed to friction with the shaft merely at the shaft contact section. For this purpose, it is advantageous if the shaft contact section is formed between the ends of the conductor section, a fraying of the ends of the conductor section promoted by the friction being prohibited, whereby the conductor section has a longer service life. A shaft contact section formed on the free end of the conductor section can more easily have a larger distance to the holder ring or the positioning element, in particular if the conductor section has a larger total length.

The conductor section can essentially be in the shape of a rod or be circular or a combination thereof. In this context, the conductor section can be exclusively in the shape of a rod or a circular arc; circular arc meaning that the shape of the conductor section corresponds at least to a part of a circumference of a circle. An elliptical arc is also conceivable in place of a circular arc. An embodiment of the circular arc is not, however, limited to the shapes described above. A combination, for example via realized arcs in an otherwise rod-shaped conductor, are also conceivable.

The conductor assembly can comprise two, preferably four, particularly preferably six, or more conductors, the conductors each being able to be held on a positioning element. To this end, a corresponding arrangement and number of conductors on the holder ring can be chosen according to the size of the shaft and/or to the extent electrostatic charges occur.

The conductors can be disposed essentially symmetrically on the holder. The conductors can be disposed rotationally symmetrically on the holder ring, whereby the conductor element can be easily produced and the shaft can be evenly contacted. However, the conductors can also be disposed axially symmetrically, in particular when the shaft is contacted on a front face. Alternatively, the conductors can be disposed asymmetrically on the holder ring. Advantageously, the conductors can cause a contacting of the shaft independently of their rotational direction.

A coinciding or differently sized contact force can be applied to the shaft via the conductors. This can be realized by the shaft contact sections of the conductor sections being spaced apart at different distances from the holder ring or the positioning element. A defined contact pressure can be exerted owing to the position of the conductor element in relation to the shaft, the contact pressure causing a prestressing of the conductors which in turn can be of the same or different magnitude for the individual conductors. A contact force of differing magnitude is advantageous in particular when normal vibrations of the shaft pose a risk of a contacting of the shaft becoming lost, even if only temporarily. The differing magnitudes of contact force and the different distances from the holder ring or positioning element can prevent such a lost contact, since at least one of the conductors is always in contact with the shaft.

Advantageously, the positioning element can be realized as a spring element, a force being able to be applied to the conductor towards the shaft via the spring element. In this context, a defined spring force can be exerted on the conductor via the spring element, meaning a defined contact pressure of the conductor on the shaft can be realized. The defined contact pressure can be taken into consideration for determining wear of the conductor. The conductor can, moreover, be formed shorter via the spring element, whereby less material is needed for producing the conductor. Since merely the conductor is exposed to wear via the contacting with the shaft and must be exchanged regularly, costs can be reduced via the service life of the conductor element.

The spring element can be a leaf spring. A leaf spring is a particularly simple embodiment of the spring element, which can be produced using little material. Moreover, the leaf spring can be used in a space-saving manner in the conductor element.

Furthermore, it is advantageous if the holder ring has at least two segments which each form a part of the circumference of the holder ring, the segments being able to be connected in a non-permanent force-fitting and/or form-fitting manner. The segments can divide the holder ring and thus the holder in at least two equal or differently sized sections. The segments can be simply disposed on the shaft and assembled upon mounting. By dividing the holder ring into said segments, the conductor element can be easily demounted without damage. The segments can be connected via a snap connection. Alternatively, the segments can be screwed together.

The rail vehicle according to the disclosure comprises at least one conductor element according to the disclosure. To this end, the rail vehicle can be in particular a train, a tram or the like. Advantageous embodiments of the rail vehicle are derived from the description of features of the dependent claims referring to claim 1.

The method according to the disclosure for conducting electrostatic charges from a shaft takes place using a conductor element, the conductor element comprising a holder and a conductor assembly, the holder having a holder ring and the conductor assembly having at least one elastic conductor disposed on the holder, the conductor being made of a carbon fiber assembly and having a shaft contact section for contacting the shaft, the shaft being tangentially contacted at a circumference of the shaft by means of the conductor. The conductor element has at least one positioning element, the conductor being held at the positioning element and the positioning element being disposed in such a manner on the holder that a position of the shaft contact section is set in relation to the shaft. With regard to the description of advantages of the method according to the disclosure, reference is made to the description of advantages of the conductor element according to the disclosure. Advantageous embodiments of the method are derived from the description of features of the dependent claims referring to claim 1.

In the following, preferred embodiments of the disclosure are described in more detail with reference to the attached drawings.

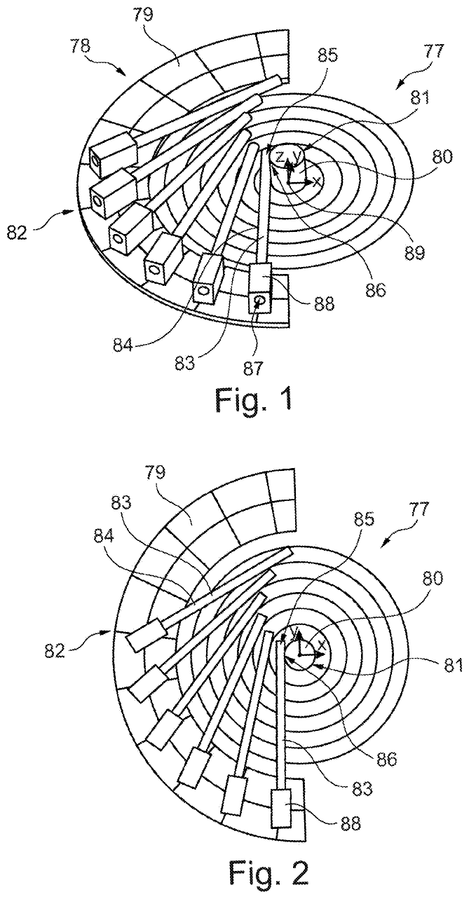

FIG. 1 shows a perspective partial view of a conductor element in a first embodiment:

FIG. 2 shows another partial view of the first embodiment of the conductor element:

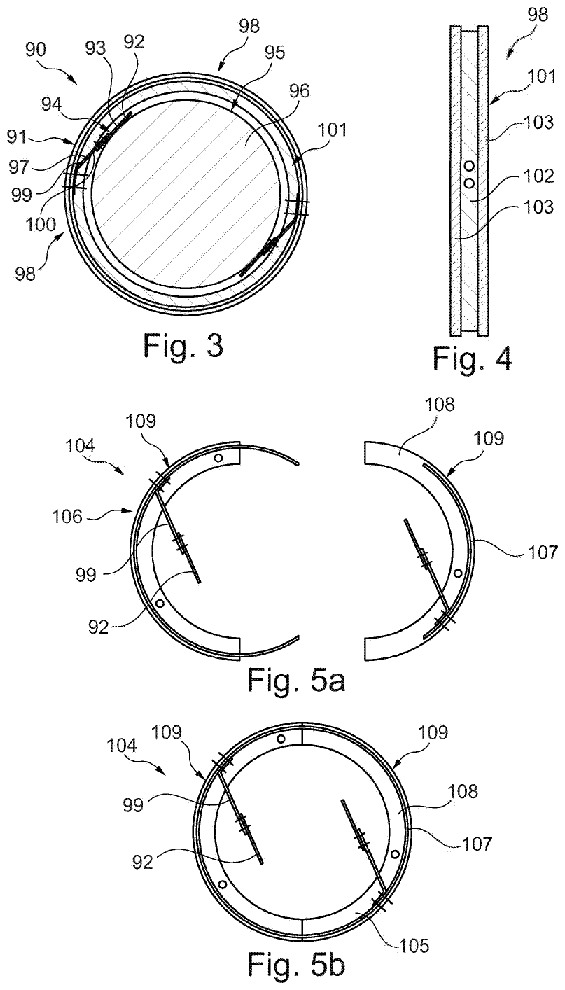

FIG. 3 shows a schematic view of a conductor element according to a second embodiment;

FIG. 4 shows a side view of the second embodiment of the conductor element:

FIG. 5a shows a schematic view of a demounted conductor element according to a third embodiment;

FIG. 5b shows a schematic view of the mounted conductor element according to the third embodiment:

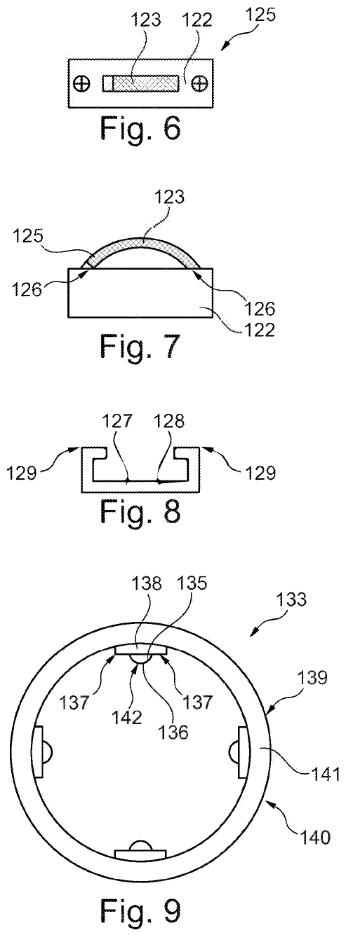

FIG. 6 shows a top view of a positioning element according to a third embodiment having a conductor:

FIG. 7 shows a side view of the first embodiment of the positioning element having the conductor:

FIG. 8 shows a schematic view of a conductor:

FIG. 9 shows a schematic view of a conductor element in a fourth embodiment.

FIG. 1 and FIG. 2 each show a part a conductor element 77 having a holder 78, a holder ring 79 of holder 78 being shown only partially. Conductor element 77 is suitable for contacting differently sized shafts 80. A contacting is intended at a circumference 81 of corresponding shaft 80 in this context. It is essential that a conductor assembly 82 of conductor element 77 comprises a plurality of conductors 83 of which six conductors 83 are shown exemplarily. Conductors 83 are realized as conductor sections 84 each having a free end 85. Free end 85 additionally forms a shaft contact section 86. An end 87 of conductor section 84 opposite free end 85 is fastened on a positioning element 88 of conductor element 77. Positioning element 88 is disposed on holder ring 79 on a front face and has a cuboidal shape. Positioning elements 88 and conductor sections 84 fastened thereto are not oriented radially to a longitudinal axis 89 of shaft 80, but oriented at an angle deviating therefrom, namely an angle preferably between 1° and 45°. Shaft contact section 86 of each conductor 83 can be tangentially contacted with circumference 81 of shaft 80 via such a position (FIG. 2). The holder ring can additionally have recesses (not illustrated) for receiving positioning elements 88.

A combined view of FIG. 3 and FIG. 4 shows a conductor element 90 which comprises a conductor assembly 91 having two conductors 92 which are formed as conductor sections 93. In doing so, shaft contact sections 94 of conductor sections 93 contact a circumference 95 of a shaft 96. Each conductor section 93 is fastened to a positioning element 97 of conductor element 90, positioning element 97 being formed as a spring element 99 which is a leaf spring 100 in this case. In this context, a force is applied to conductor section 93 towards shaft 96 via spring element 99, a contact force of conductor section 93 being enlarged by the spring force of spring element 99. Spring element 99 is connectable to both conductor section 93 and to a holder ring 101 of a holder 98 of conductor element 90 in a non-permanent, i.e., force-fitting and/or form-fitting, manner. Moreover, holder ring 101 is assembled from an inner ring 102 and two outer rings 103 abutting against inner ring 102.

Conductor element 104 shown in FIG. 5a and FIG. 5b differs from the conductor element shown in FIG. 3 in that a holder ring 105 of a holder 106 of conductor element 104, which is assembled from an inner ring 107 and two outer rings 108, is dividable into at least two segments 109, segments 109 being connectable in a non-permanent force-fitting and/or form-fitting manner. A division of this kind of holder ring 105 into segments 109 serves for mounting or demounting conductor element 104 in a simplified manner. Advantageously, inner ring 107 of holder ring 105 can be divided at a ratio of 2:1 and outer rings 108 of holder ring 105 can be divided at a ratio of 1:1 into corresponding segments 109. Other divisions of holder ring 105 which deviate therefrom are also conceivable.

A combined view of FIG. 6 and FIG. 7 shows a positioning element 122 having a conductor 123. Conductor 123 is formed as a conductor section 125 whose opposite ends are inserted into and/or are fastened to positioning element 122. Positioning element 122 is cuboidal in shape in this case.

FIG. 8 exemplarily shows another conductor 127 for a conductor element (not illustrated) which can be used alternatively to the conductor in FIG. 6 or 7. Conductor 127 is formed as a conductor section 128, whose opposite ends 129 are angled and/or bent twice. Forming conductor 127 in this manner allows inserting it into a positioning element (not illustrated) in a simplified manner.

FIG. 9 shows a conductor element 133, conductor element 133 having a conductor assembly 134 whose conductors 135 are realized as conductor sections 136. In this context, opposite ends 137 of conductor sections 136 are each fastened to a positioning element 138 of conductor element 133. Block-shaped positioning elements 138 are disposed on an inner circumference 140 of a holder ring 141 of a holder 139 of conductor element 133, positioning elements 138 being connectable to holder ring 141 in a non-permanent manner. A conductor element 133 of this kind is suitable for contacting a circumference of a shaft (not illustrated). In this context, it is intended that conductor sections 136 form a shaft contact section 142 between ends 137 via the position of conductor element 133 on the shaft (not illustrated), a force being able to be applied to the shaft (not illustrated) when contacted via conductors 135.

1. A conductor element for conducting electrostatic charges from a shaft, the conductor element comprising a holder and a conductor assembly, the holder having a holder ring and the conductor assembly having at least one elastic conductor disposed on the holder, the conductor being made of a carbon fiber assembly and having a shaft contact section for contacting the shaft, the shaft being able to be contacted tangentially at a circumference of the shaft by means of the conductor, characterized in that wherein the conductor element has at least one positioning element, the conductor being held at the positioning element and the positioning element being disposed in such a manner on the holder that a position of the shaft contact section is able to be set in relation to the shaft.

2. The conductor element according to claim 1, wherein the carbon fiber assembly is made of a braid of carbon fibers, the carbon fiber assembly being infiltrated with pyrolytic carbon, the carbon fiber assembly being inherently stable in such a manner via the infiltration with pyrolytic carbon that a contact force is able to be applied to the shaft via the contact fiber assembly.

3. The conductor element according to claim 1, wherein the positioning element is disposed on a front face of the holder ring or on an inner circumference of the holder ring, the positioning element being connected to the holder ring in a force-fitting and/or form-fitting manner.

4. The conductor element according to claim 1, wherein the positioning element is inserted into at least one recess of the holder ring formed according to the positioning element.

5. The conductor element according to claim 4, wherein the holder ring has two or more recesses.

6. The conductor element according to claim 1, wherein the positioning element is cuboidal or cylindrical in shape and has at least one opening in which the conductor is inserted.

7. The conductor element according to claim 1, wherein the conductor is realized as a conductor section having two opposite ends.

8. The conductor element according to claim 7, wherein the ends of the conductor section are fastened to the positioning element.

9. The conductor element according to claim 7, wherein the conductor section has at least one free end.

10. The conductor element according to claim 9, wherein the conductor section has an end fastened to the positioning element.

11. The conductor element according to claim 7, wherein the conductor section has at least one section between the ends on which the conductor section is fastened to the holder.

12. The conductor section according to claim 7, wherein the shaft contact section is formed at the free end of the conductor section of between the ends of the conductor sections.

13. The conductor element according to claim 7, wherein the conductor section is formed essentially in the shape of a rod or a circular arc or a combination thereof.

14. The conductor element according to claim 1, wherein the conductor assembly comprises two or more conductors, the conductors each being held on a positioning element.

15. The conductor element according to claim 14, wherein the conductors are disposed essentially symmetrically on the holder.

16. The conductor element according to claim 14, wherein a contact force which coincides in each case or varies in force is able to be applied to the shaft via the conductors.

17. The conductor element according to claim 1, wherein the positioning element is formed as a spring element, a force being able to be applied to the conductor towards the shaft via the spring element.

18. The conductor element according to claim 17, wherein the spring element is a leaf spring.

19. The conductor element according to claim 1, wherein the holder ring has at least two segments which each form a part of a circumference of the holder ring, the segments being connectable in a non-permanent force-fitting and/or form-fitting manner.

20. A rail vehicle having at least one conductor element according to claim 1.

21. A method for conducting electrostatic charges from a shaft using a conductor element, the conductor element comprising a holder and a conductor assembly, the holder having a holder ring and the conductor assembly having at least one elastic conductor disposed on the holder, the conductor being made of a carbon fiber assembly and having a shaft contact section for contacting the shaft, the shaft being tangentially contacted at a circumference of the shaft by means of the conductor, wherein the conductor element has at least one positioning element, the conductor being held at the positioning element and the positioning element being disposed in such a manner on the holder that a position of the shaft contact section is set in relation to the shaft.

22. The conductor element according to claim 1, wherein the positioning element and the conductor are connectable in a non-permanent manner.
